(19) United States
(12) Patent Application Publication
(10) Pub. No.: US 2009/0323580 A1
(43) Pub. Date: Dec. 31, 2009

(54) Frame structure and sequencing for enabling network coding for wireless relaying

(76) Inventors: Feng Xue, Emeryville, CA (US); Jaroslaw J. Sydir, San Jose, CA (US)

Correspondence Address: INTEL CORPORATION;c/o CPA Global, P.O. BOX 52050, MINNEAPOLIS, MN, 55402, US

(21) Appl. No.: 12/215,544

(22) Filed: Jun. 27, 2008

(51) Int. Cl. H04Q 7/00; H04Q 7/20; H04B 7/14

(52) U.S. Cl. 370/315; 370/328; 455/561

(57) ABSTRACT

In a wireless network, when using an intermediate node to relay two-way communications between two other nodes, the data sets going in opposite directions may be intercepted and XOR'd together by the intermediate node to produce a third data set. The third data set may then be transmitted simultaneously to both destination nodes (e.g., through a multicast transmission), which each use another XOR operation to produce the message intended for them. Identification numbers may be appended to the various messages to allow each node to keep track of which messages are intended for it, and which data to use in the XOR operation. If bidirectional network traffic is unbalanced, separate time periods may be established by a network controller for transmission of data sets that are to be coded and those that are not.

### BACKGROUND

In some types of wireless networks, a relay station (RS) is used to relay communications between a base station (BS) and a subscriber station (SS) when direct communication between the BS and SS is not reliable or feasible. This condition may exist because the BS and SS are too far apart, because there are obstructions to the direct signal, because network protocols require an intermediate node, or for other reasons. However, using this technique may cause a simple two-way exchange between a BS and an SS to require four transmissions instead of two (BS to RS, RS to SS, and SS to RS, RS to BS, instead of BS to SS, and SS to BS).

### BRIEF DESCRIPTION OF THE DRAWINGS

Some embodiments of the invention may be understood by referring to the following description and accompanying drawings that are used to illustrate embodiments of the invention. In the drawings:

FIG. 1 shows three nodes of a wireless network, according to an embodiment of the invention.

FIG. 2 shows a specific exchange of messages in the network of FIG. 1, according to an embodiment of the invention.

FIG. 3 shows a sequence of data sets and identification numbers used in a multi-link communications sequence, according to an embodiment of the invention.

FIG. 4 shows a flow diagram of a method of handling communications by an intermediate node in a wireless network, according to an embodiment of the invention.

FIG. 5 shows a flow diagram of a method of handling communications with an intermediate node in a wireless network, according to an embodiment of the invention.

FIGS. 6 and 7 show diagrams of the temporal allocation of time zones in a network, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a tangible storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not.

Within the context of this document, the term “destined for” a particular node, when used in connection with a communication between wireless nodes in a network, indicates that the communication is intended to be conveyed to the particular node, although it may or may not have to be routed through at least one intermediate node first. The term “addressed to” a particular node indicates that the communication is intended to go directly to the particular node without going through an intermediate node.

Within the context of this document, the term “data set” means the portion of the transmission that is subject to the encoding/decoding operations described. In some embodiments it may exclude any preamble, header, etc., that is specific to conveying that particular transmission to the addressed node. (Data integrity check fields may or may not be excluded, depending on the particular implementation.) The data set also excludes the identification numbers that are described later that are used to track specific data sets as those data sets travel between nodes. However, other headers, checksums, identification parameters, etc., that are not used in the three-node exchange of these embodiments, but are used by other nodes before or after this exchange, might be embedded in the data set and may be invisible to the three nodes. Those may be considered part of the data set. In some embodiments, multiple data sets may be included in a single transmission. In some embodiments, a dataset may be equivalent to other recognized amounts of data, such as but not limited to: 1) a packet, 2) a protocol data unit, 3) any other feasible recognized data unit, 4) multiple ones of any of those, 5) a fixed number of bits or bytes, 6) etc.

Various embodiments of the invention facilitate the use of network coding in a wireless network, in which two-way data that flows between two nodes through a third node is encoded by that third node and transmitted to both nodes simultaneously to reduce the total number of transmissions needed to complete the two-way transfer. Identification numbers may be assigned to each data set by the originating node, and included with the transmission. When an encoded transmission is subsequently received, the identification number may be used to identify which transmission was used in the encoding process, so that the received data set may be properly decoded. Note: the identification numbers described in this document are identification numbers associated with the described coding/decoding operations. Other types of identification numbers may also be included in the transmission and used for other purposes, but those are not described in this disclosure.

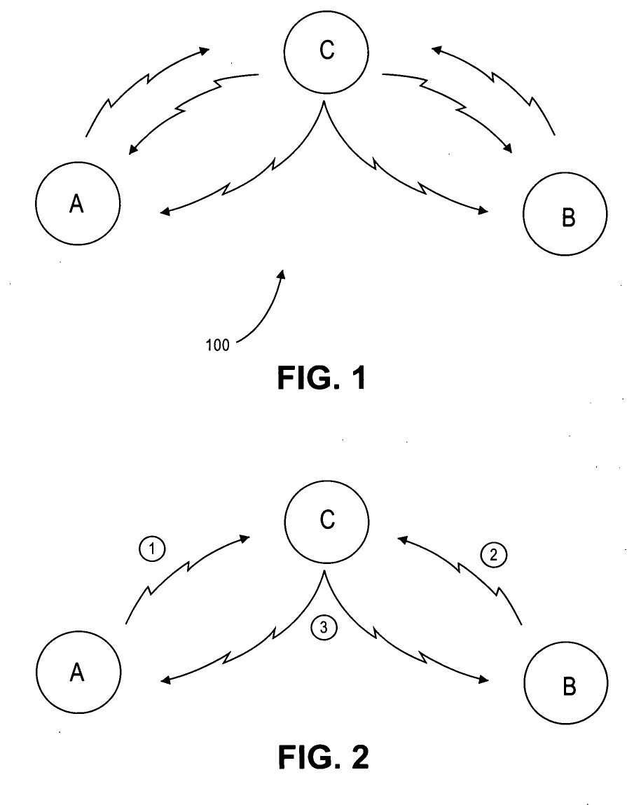

FIG. 1 shows three nodes of a wireless network, according to an embodiment of the invention. In the illustrated network 100, comprising network nodes A, B, and C, it is assumed that nodes A and B are not communicating directly with each other, but rather communicate with each other indirectly through an intermediate node C. This may occur for various reason's. For example, nodes A and B may not be able to communicate directly with each other because the received signal strength of direct communication is too weak (e.g., they are too far apart, there is a signal-blocking obstruction between them, etc.), while each of nodes A and B is capable of communicating directly with node C, which acts as a relay station. Alternately, network protocols may require them to communicate indirectly (for example, subscriber stations A and B may be allowed to communicate directly only with base station C).

In these scenarios, a message from node A that is destined for node B may first be transmitted from node A to node C, and then retransmitted (in the same or different form) from node C to node B. Similarly, a message from node B that is destined for node A may first be transmitted from node B to node C, and then retransmitted from node C to node A. Such communications frequently involve unicast addressing; i.e., each transmitted message is addressed to a single, specific node, and only that node accepts it. However, multicast addressing may also be feasible in the network, in which a single message is addressed to multiple specific nodes, and each of the addressed nodes receives and accepts the same message. This is also illustrated in FIG. 1, by depicting a single signal going from node C to both nodes A and B.

FIG. 2 shows a specific exchange of messages in the network of FIG. 1, according to an embodiment of the invention. A transmission 1 from node A is addressed to node C, although the data set in transmission 1 is destined for node B. Similarly, a transmission 2 from node B is addressed to node C, although the data set in transmission 2 is destined for node A. Transmissions 1 and 2 may be received by node C in either order. After receiving both messages, node C may encode the data sets from both messages into a third data set, and multicast that third data set to both nodes A and B in transmission 3. Node A may then decode the received third data set to re-create the data set from node B that was previously contained in transmission 2. Similarly, node B may decode the received third data set to re-create the data set from node A that was previously contained in transmission 1. The specifics of encoding and decoding are described later.

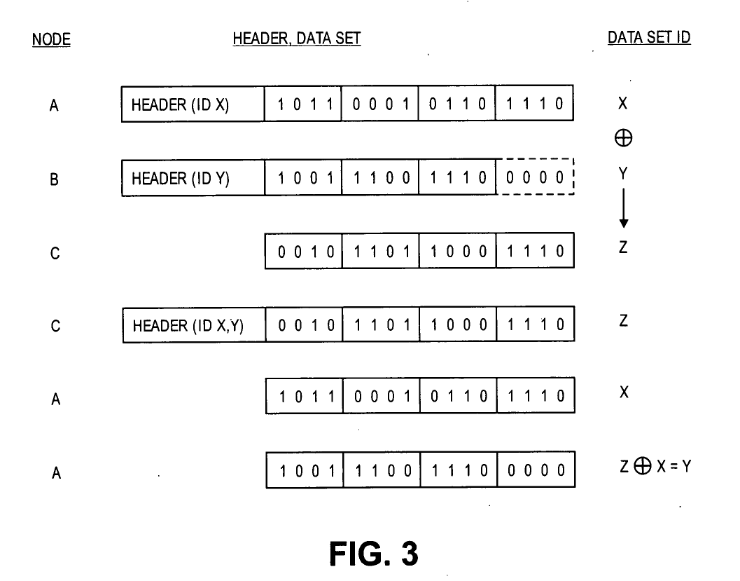

FIG. 3 shows a sequence of data sets and identification numbers used in a multi-link communications sequence, according to an embodiment of the invention. In the illustrated embodiment, node A may construct and transmit to node C a communication containing a data set that is destined for node B, preceded by a header containing an identification number (ID#) labeled X, that is associated with this particular data set. Similarly, node B may construct and transmit to node C a communication containing a data set that is destined for node A, preceded by a header containing an ID# labeled Y, that is associated with this particular data set. For ease of illustration, data set X is shown as 16 bits long and data set Y is shown as 12 bits long, though in actual practice the data sets may typically be much longer. Note: here, and elsewhere in this document, nodes A and B may each be described as transmitting a single data set with a header containing a single ID associated with the data set. But in some embodiments, either or both nodes may transmit multiple data sets in a single transmission, with a separate ID for each data set contained in the same header.

When node C receives the two communications, it may perform a bitwise exclusive OR (XOR) operation on the two data sets to produce a third data set Z. Since data sets X and Y need to be of equal length for this operation, the data set Y has four 0's appended to it to make it the same size as data set X. Alternately, other known data patterns may be added to either the beginning or end of the shorter of the two data sets to make them equal in length.

Node C may then add a header to data set Z, with the header containing ID #s X and Y, and multicast the header and data set Z to both nodes A and B. When node A receives this transmission, it can tell from the header that its data set X was used to create data set Z. Node A may then perform another bitwise XOR operation between data set Z and a copy of the original data set X (which node A saved). This operation creates data set Y, which is the data set from node B that was destined for node A. Data in the header may indicate the original length of data set B, so that node A may remove the extra bits that were appended by node C. Similarly, node B may perform an XOR between data sets Z and Y to produce data set X. The total number of transmissions in this sequence is three (A to C, B to C, and C to A,B), rather than the four that would be necessary if node C simply retransmitted the data (A to C, C to B, and B to C, C to A). This technique can be advantageous if the added processing is less time consuming, or more available, than the extra network bandwidth required by the conventional technique. Although the operation described above is a bit-wise exclusive OR operation, other embodiments may use other types of reversible operation.

Each communication may contain other information not specifically described or shown in the figures. For example, a CRC or other check field to verify the integrity of the received data may follow the data set (or in some embodiments may be included at the end of the data set). The header may include other information not specifically shown here. As an example, the header preceding data set X or Y may contain a flag indicating if the data set is eligible for the described coding process. If it is, an ID# may also be included in the header. If the flag indicates the data set is not eligible for the coding process, an ID# may be absent from the header (or the ID# field may simply be ignored). Alternatively, a predetermined value (such as all 0's) in the ID# field may indicate the ID# field should be ignored and that the data set is not eligible for the coding described herein.

There are reasons why it might not be desirable to make the data set eligible for this process. For instance (using the example of FIG. 3), node A cannot decode data set Z unless it saves a copy of data set X. Saving a copy of every transmission may consume an unreasonable amount of storage space in node A, and a copy of a particular data set need not be stored if that data set won't subsequently be encoded by node C. Further, the coding process can only take place if node B transmits a data set destined for node A. In some environments, this may not occur very often, so node A may avoid storing any data sets destined for node B, and save that storage for data set exchanges with other nodes. By receiving a notice from node A that a certain data set is not eligible for coding, node C may avoid unnecessarily encoding a data set that node A will subsequently not be able to decode. Note: the ‘coding’ process referred to in this document refers only to the described coding process. Data sets may be encoded in other ways for other reasons (such as security), but those coding techniques are not part of this description, and are ignored here.

In a related aspect, node C may choose not to encode a data set, even if the associated flag makes that data set eligible for coding. For example, if node C receives a data set X from node A that is eligible for coding and is destined for node B, but receives no eligible data set from node B that is destined for node A, then node C may choose to simply transmit data set X to node B without coding. Since node A is still saving a copy of data set X, but will never get a coded data set that requires it, then node A may need to know that the copy of dataset X won't be needed and node A can delete its copy of dataset X. This information may be conveyed from node C to node A in any feasible manner. For example, a direct technique would be for node C to make a transmission to node A notifying node A that dataset X was transmitted to node B without being coded. An indirect technique would be for node A to simply listen to the transmission of dataset X from node C to node B. When node A sees the transmission to node B was uncoded, node A can delete it's copy of dataset X. Depending on the header structure, node A may be able to determine that the transmission from node C to node B was not encoded simply by examining a particular field in the header of that transmission, and won't need to monitor the actual data transmission portion. Other techniques may also be used.

The data sets described in this document may represent any feasible unit of communications information. For example, the data set, with or without the header, may be represented by a packet, a protocol data unit (PDU), any other defined unit of communication, or by multiple ones of any of these. The data set and associated header may or may not be immediately preceded by a preamble, and may or may not be immediately followed by a check field. However, it is necessary that the length of the data set is either specified in the communication, or is known through some other means (such as by using a predefined size), so that node C can make any necessary adjustments in size to assure the XOR operation can be performed.

In some embodiments, multiple data sets from a node (e.g., from node B). may be combined into a single larger data set in node C before encoding. This larger data set may then be encoded with a similarly-sized data set (either an original data set or another combined data set), and the encoded result transmitted by node C. In some embodiments, the ID numbers for each of the smaller data sets may be stripped before combining, and then added to the encoded combined data set before transmitting, so that all the relevant ID#'s will be available to the receiving device. The ID#'s and the location of each encoded data set in the transmission may be specified in the header for the encoded data set. As long as the originating node (e.g., node A or node B) knows which of its own original data sets are contained in the encoded larger data set, and where they are located in that larger data set, the originating node may still decode the encoded data set properly.

It is important that each of nodes A and B can unambiguously identify a particular data set from its ID#. Since numerous ID#s may active in a network, or even in a given node, at the same time, care should be taken that a node doesn't have a stored data set with an ID# that can be confused with the ID# of a different data set originated in another node. Various means may be used to avoid this confusion. For example, a unique range of ID#s may be pre-assigned to each node, so that two different nodes cannot assign the same ID# to their respective data sets. Alternately, the identification of the node that assigned the ID# may be included in the header, and/or considered a part of the ID#, so that ID#s from two different nodes are still distinguishable. Other techniques may also be used.

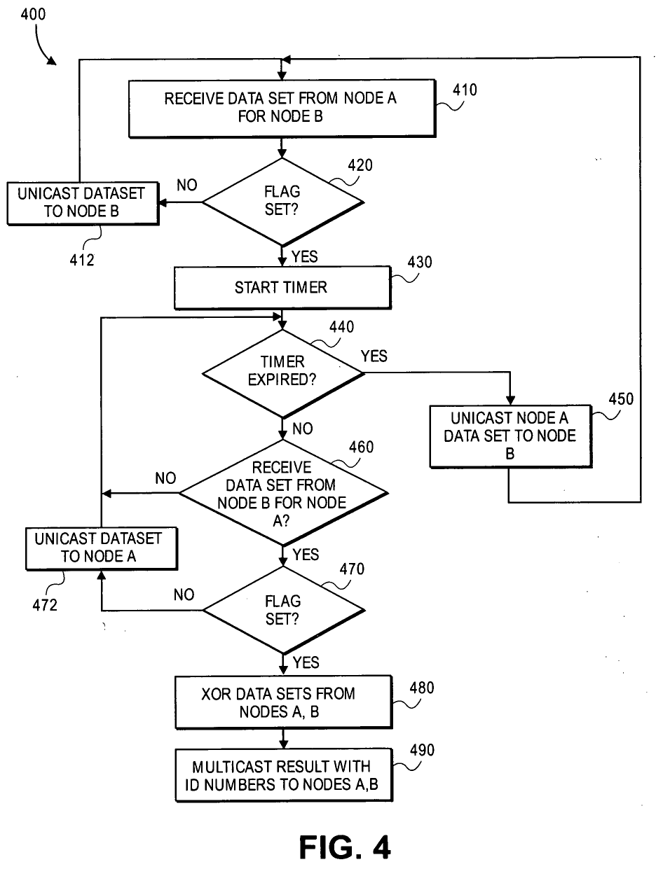

FIG. 4 shows a flow diagram of a method of handling communications by an intermediate node in a wireless network, according to an embodiment of the invention. The illustrated flow diagram 400 references operations within intermediate node C of FIG. 2, when nodes A and B are transmitting data sets destined for each other that are routed through node C. At 410 the intermediate node C may receive a transmission containing a dataset that was transmitted from node A and is destined for node B. If the transmission does not have the network coding flag set, as determined at 420, thereby indicating that the data set is not eligible for network coding, then the data set may be transmitted to node B at 412, and node C may wait to receive another data set at 410.

But if the network coding flag is set, then the data set and the associated identification number are held for subsequent network coding operations. Since network coding requires eligible data sets from both node A and node B, and node B may not provide an eligible data set for a long time, a timer may be started at 430. If the timer expires at 440 before an eligible data set is received from node B, then the data set previously received from node A may simply be transmitted to node B at 450 without coding. This would typically be a unicast transmission, but some operations may differ.

If a data set for node A is received at 460 from node B before the timer expires, but the network coding flag is not set for that data set, then the data set may be unicast to node A at 472. However, if that data set does have the network coding flag set as determined at 470, then a network coding operation may be performed at 480 by performing a bit-wise XOR operation on the two data sets to produce a third data set. As previously described, the shorter of these two data sets may have additional bits added to it so that the two data sets will be of equal length, simplifying the XOR operation. This third data set may then be multicast to nodes A and B at 490. The multicast transmission may contain both of the identification numbers that were received in the transmissions previously received from nodes A and B, so that nodes A and B can identify which of their previous transmissions were used to create this third data set.

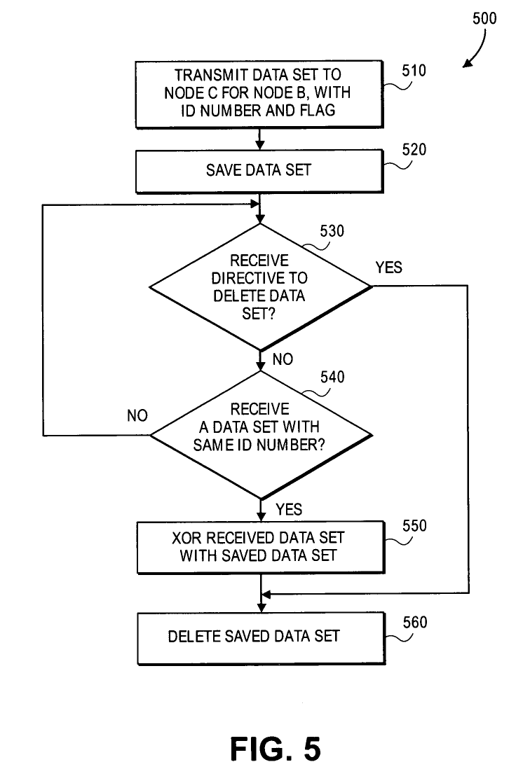

FIG. 5 shows a flow diagram of a method of handling communications with an intermediate node in a wireless network, according to an embodiment of the invention. The illustrated flow diagram 500 references operations within node A of FIG. 2, when nodes A and B are transmitting data sets destined for each other that are routed through node C. At 510, node A may transmit a data set to intermediate node C, the data set being destined for node B. The transmission may have the network coding flag set, indicating this data set is eligible for network coding, and may also include an associated identification number. (If the data set is not eligible for network coding, then this flow diagram doe not apply to it.) The data set is also saved at 520, so that it can be used later for decoding purposes.

If a subsequent transmission from node C is received, and that transmission contains a directive at 530 to delete the saved data set, then the data set is deleted at 560. This may occur because node C forwarded the data set to node B without network coding, and the saved data set therefore no longer serves a useful purpose in node A. Although expressed at 530 as a ‘directive’ to delete, this may simply be a notification that the data set was forwarded without coding. In some operations, a notification that the data set could not be delivered at all (e g., node B cannot be found), would also trigger deletion of the saved data set at 560.

If a transmission from node C is received at 540, and that transmission contains the identification number that node A originally included in its transmission to node C at 510, this may indicate that this transmission from node C contains a data set from node B that has been network coded with the data set from node A (e.g., as coded at 480 of FIG. 4). This encoded data set may be decoded by performing a bit-wise XOR operation between the data set received from node C at 540, and the data set saved at 520. This operation should produce the data set that was originally transmitted from node B to node C, and that was destined for node A. Once the data set has been successfully decoded in this manner, the saved data set may be deleted at 560.

The preceding flow diagrams have assumed that the relevant portions of each transmission were received correctly without error, or that the error(s) could be corrected by the receiving node. If such was not the case, then the incorrectly received portions may be ignored, and a request made to retransmit the data. The retransmission would then be subject to the operations in the flow diagrams.

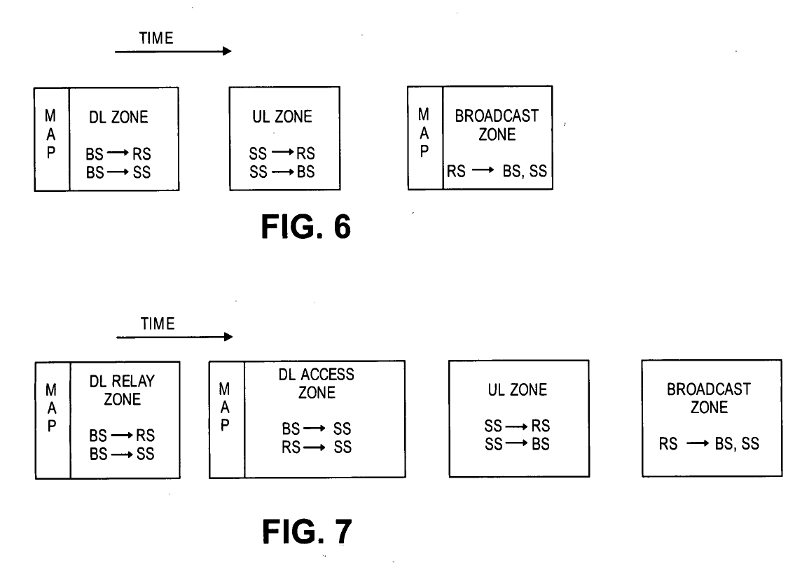

FIGS. 6 and 7 show diagrams of the temporal allocation of time zones in a network, according to an embodiment of the invention. Various time periods may be allocated by a network controller to designate when each type of transmission is permitted. The example shows uplink (UL), downlink (DL), and Broadcast zones (time periods), during which only the designated transmissions may be made. Within the context of this document, a Broadcast zone is a time period during which the same transmission may be simultaneously made to two or more devices, to at least one device in the uplink direction and to at least one device in the downlink direction. The diagrams resemble communication diagrams for Orthogonal Frequency Division Multiple Access OFDMA) techniques, with maps at the beginning of certain transmission periods to specify when during each period each device is allowed to transmit. OFDMA techniques may be used in various embodiments of the invention, but other techniques may also be used. The abbreviations BS, RS, and SS refer to base station, relay station, and subscriber station, respectively, in a network in which the relay stations act as the intermediate node between the base station and at least some of the subscriber stations. In many situations, some SS's in the network may be able to communicate directly with the BS without an intermediate RS. These are referred to here as direct-connect SS's, and accommodation is made for them in these examples.

In the example of FIG. 6, the BS may transmit a map defining the time periods within the DL zone during which the BS transmits to the RS's and to direct-connect SS's, and also defining the time periods within the UL zone during which the SS's transmit to the RS's, or to the BS for direct-connect SS's. Since the SS's may not be able to receive this timing information until it is relayed by the RS's, the uplink time period defined in the map may be for a subsequent series of communications, and the illustrated UL zone may have been defined by the map in a previous series of communications. The Broadcast zone may be defined by the map at the beginning of the Broadcast zone, in another transmission from the BS to the RS's. During the Broadcast zone, the RS's may transmit their multicast transmissions to the BS and SS's. Since it is unlikely that every communication from the BS to the RS that is destined for a particular SS will be balanced by a communication from that particular SS to the RS that is destined for the BS, unicast transmissions from the RS may also be made during this period for uncoded data sets from the RS in either direction.

In the example of FIG. 7, a DL zone, an UL zone, and a Broadcast zone may be used in the manner described in FIG. 6. However, a second DL zone may also be used for unencoded downlink transmissions to the SS's. This second DL zone may also include any downlink transmissions from the BS to direct-connect SS's that were not included in the first DL zone. This format may be preferable when the volume of downlink traffic greatly exceeds the volume of uplink traffic. In the illustrated example, the two DL zones are labeled DL Relay zone and DL Access zone to distinguish them from each other, but other labels may also be used. One difference from the scenario of FIG. 6 is in which time periods are defined by which maps. In FIG. 6 the DL zone and UL zone are both defined by the map at the beginning of the DL zone (a conventional approach for OFDMA), while the Broadcast zone has its own map. In FIG. 7, the map at the beginning of the DL Relay zone may define the DL Relay zone and the Broadcast zone, while the map at the beginning of the DL Access zone may define the DL Access zone and the UL zone. Other map arrangements may also be used in other embodiments.

Although the foregoing examples have been described in terms of a relay station acting as an intermediate node between a base station and a subscriber station, other embodiments may use other configurations, such as but not limited to a network controller acting as an intermediate node to relay communications between two mobile stations in a network.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a first wireless communications device in a wireless network, the first wireless communications device comprising a processor, a memory, and a wireless communications interface, the first wireless communications device configured to:
receive a first wireless transmission from a second wireless communications device and destined for a third wireless communications device, the first wireless transmission containing a first data set and a first identification number associated with the first data set;
receive a second wireless transmission from the third wireless communications device and destined for the second wireless communications device, the second wireless transmission containing a second data set and a second identification number associated with the second data set;
perform a bitwise exclusive OR (XOR) operation between the first and second data sets to produce a third data set; and
transmit the third data set in a third wireless transmission addressed to both the second and third wireless communications devices, the third wireless transmission containing both the first and second identification numbers;
wherein the first and second identification numbers are not included in the bitwise XOR operation.

2. The apparatus of claim 1, wherein the first wireless communications device is to transmit the third wireless transmission in a multicast transmission.

3. The apparatus of claim 1, wherein the first wireless communications device is to transmit the first and second identification numbers before the third data set in the third wireless transmission.

4. The apparatus of claim 1, wherein the first wireless communications device comprises at least one antenna to receive the first and second wireless transmissions and to transmit the third wireless transmission.

5. The apparatus of claim 1, wherein the first wireless transmission includes a flag to indicate the first data set is eligible for coding using the bitwise XOR operation.

6. An apparatus comprising
a first wireless communications device to communicate as a node in a wireless network, the first wireless communications device comprising a processor, a memory, and a wireless communications interface, the first wireless communications device configured to:
transmit a first data set in a first wireless transmission to a second wireless communications device, the first wireless transmission being destined for a third wireless communications device and containing a first identification number associated with the first data set;
save a copy of the first data set;
receive, from the second wireless communications device, a second data set in a second wireless transmission containing the first identification number; and
perform a bitwise XOR operation between the second data set and the copy of the first data set to produce a third data set representing data from the third wireless communications device.

7. The apparatus of claim 6, wherein the second wireless transmission is to comprise a multicast wireless transmission.

8. The apparatus of claim 6, wherein the first wireless communications device comprises a battery to power the processor, memory, and wireless communications interface.

9. The apparatus of claim 6, wherein the first wireless communications device comprises at least one antenna to transmit and receive the wireless transmissions.

10. A method, comprising:
receiving a first data set in a first wireless transmission from a first network node and destined for a second network node, the first wireless transmission including a first identification number associated with the first data set;
receiving a second data set in a second wireless transmission from the second network node and destined for the first network node, the second wireless transmission including a second identification number associated with the second data set;
performing a bitwise XOR operation between the first and second data sets to produce a third data set; and
transmitting the third data set in a third wireless transmission including the first and second identification numbers and destined for both the first and second network nodes.

11. The method of claim 10, wherein the third wireless transmission is a multicast transmission.

12. The method of claim 10, wherein the first wireless transmission includes a flag to indicate that the first data set is eligible to be encoded using the bitwise XOR operation.

13. The method of claim 10, wherein the first and second identification numbers are in a header in the third wireless transmission.

14. The method of claim 10, wherein:
said receiving the first data set occurs during a first time period previously designated for downlink transmissions;
said receiving the second data set occurs during a second time period previously designated for uplink transmissions; and
said transmitting the third data set occurs during a third time period previously designated for transmission of data sets created with XOR operations.

15. The method of claim 14, further comprising transmitting a fourth data set during a fourth time period previously designated for downlink transmissions to the second network node of data sets not created with the XOR operations.

16. A method, comprising:
transmitting a first data set in a first wireless transmission to a first network node, the first wireless transmission being destined for a second network node and including a first identification number associated with the first data set;
saving a copy of the first data set;
receiving a second data set in a second wireless transmission from the first network node;
determining whether'the second wireless transmission includes the first identification number; and
performing, responsive to determining the second wireless transmission includes the first identification number, a bitwise XOR operation between the second data set and the copy of the first data set to produce a third data set representing data from the second network node.

17. The method of claim 16, wherein the second wireless transmission comprises a multicast wireless transmission.

18. The method of claim 17, wherein the second wireless transmission includes a second identification number that was used to create the second data set.

19. The method of claim 16, wherein:
said transmitting the first data set occurs during a time previously designated for transmissions to the first network node; and
said receiving the second data set occurs during a time previously designated for transmissions from the first network node.

20. An article comprising
a tangible machine-readable medium that contains instructions, which when executed by one or more processors result in performing operations comprising:
receiving a first data set in a first wireless transmission from a first network node and destined for a second network node, the first wireless transmission including a first identification number associated with the first data set;
receiving a second data set in a second wireless transmission from the second network node and destined for the first network node, the second wireless transmission including a second identification number associated with the second data set;
performing a bitwise XOR operation between the first and second data sets to produce a third data set; and
transmitting the third data set in a third wireless transmission destined for both the first and second network nodes, the third wireless transmission including both the first and second identification numbers.

21. The medium of claim 20, wherein the third wireless transmission is a multicast transmission.

22. The medium of claim 20, wherein the operation of transmitting the third wireless transmission include transmitting the first and second identification numbers in a header preceding the third data set.

23. The medium of claim 20, wherein:
the operation of receiving the first data set occurs during a first time period previously designated for downlink transmissions;
the operation of receiving the second data set occurs during a second time period previously designated for uplink transmissions; and
the operation of transmitting the third data set occurs during a third time period previously designated for transmissions from a third network node that performs the bitwise XOR operation.

24. The medium of claim 23, wherein said designations of the first, second, and third time periods are made by the third network node

25. The medium of claim 20, wherein the operations further comprise transmitting the first data set and the first identification number to the second network node without performing the XOR operation on the first data set, during a fourth time period designated for downlink transmissions of data sets to the second network node that are not coded by the bitwise XOR operation.

26. An article comprising
a tangible machine-readable medium that contains instructions, which when executed by one or more processors result in performing operations comprising:
transmitting a first data set in a first wireless transmission to a first network node, the first wireless transmission being destined for a second network node and including a first identification number associated with the first data set;
saving a copy of the first data set;
receiving a second data set in a second wireless transmission from the first network node;
determining whether the second wireless transmission includes the first identification number; and
performing, responsive to determining the second wireless transmission includes the first identification number, a bitwise XOR operation between the second data set and the copy of the first data set to produce a third data set representing data from the second network node.

27. The medium of claim 26, wherein the second wireless transmission comprises a multicast wireless transmission.

28. The medium of claim 27, wherein the second wireless transmission includes a second identification number associated with the second data set.

29. The medium of claim 26, wherein:
the operation of transmitting the first data set occurs during a time previously designated for transmissions from the device performing the bitwise XOR operation; and
the operation of receiving the second data set occurs during a time previously designated for transmissions from the first network node.
